(19) United States
(12) Patent Application Publication
(10) Pub. No.: US 2019/0278038 A1
(43) Pub. Date: Sep. 12, 2019

(54) DOWNHOLE LOGGING CABLES WITH CENTRAL CONDUCTORS

(71) Applicant: AFL Telecommunications LLC, Duncan, SC (US)

(72) Inventors: Rajesh KAMATH, Kent, WA (US); Brett VILLIGER, Simpsonville, SC (US)

(21) Appl. No.: 16/302,377

(22) PCT Filed: Jun. 2, 2017
(86) PCT No.: PCT/US2017/035661

§ 371 Date: Nov. 16, 2018

Related U.S. Application Data
(60) Provisional application No. 62/345,414, filed on Jun. 3, 2016.
(60) Provisional application No. 62/361,186, filed on Jul. 12, 2016.

(51) Int. Cl. G02B 6/44; H01B 7/04; E21B 47/12

(52) U.S. Cl. CPC G02B 6/4416; E21B 47/12; H01B 7/046; G02B 6/4488

(57) ABSTRACT

A downhole logging cable includes a central conductor. Optical fibers are provided around the central conductor. The optical fibers are disposed within a cladding which surrounds and contacts the central conductor. A jacket surrounds and contacts the cladding. At least one metal tube surrounds the jacket.

### CROSS-REFERENCE TO RELATED APPLICATIONS

This application is based upon and claims the benefit of priority from U.S. Provisional Patent Application Nos. 62/345,414, filed Jun. 3, 2016 and 62/361,186, filed Jul. 12, 2016, the disclosures of both of which are incorporated by reference herein in their entireties.

### FIELD OF THE INVENTION

The present disclosure is generally directed to downhole logging cables, and more particularly to reusable downhole logging cables having relatively small profiles.

### BACKGROUND OF THE INVENTION

In industries such as the oil and gas industry, wells are utilized to provide access to raw materials. A variety of cables may be utilized in the wells, and various of these cables may perform specified functions. One type of cable that is utilized in well settings is a downhole logging cable. Logging activities generally include the acquisition and analysis of geophysical data for the geologic formations penetrated by a well borehole. Wireline logging is performed by lowering various logging instruments on the end of a logging cable into a well borehole and recording various properties using a variety of sensors. The logging tools may measure, for example, the natural gamma ray, electrical, acoustic, stimulated radioactive responses, electromagnetic, nuclear magnetic resonance, pressure and other properties of rocks surrounding the borehole and their contained fluids.

Presently known logging cables have relatively large profiles, and are heavy, permanent installations into well boreholes. These cables generally take up a relatively significant portion of a well borehole and cannot be reusable, thus making the overall use of logging cables expensive and inefficient.

Accordingly, improved downhole logging cables are desired in the art. In particular, reusable downhole logging cables which have relatively small profiles would be advantageous. Additionally, reusable downhole logging cables which provide improved strength, temperature resistance, and bending stiffness characteristics while being capable of maintaining electrical and optical pathways to connected logging instruments would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a downhole logging cable is provided. The downhole logging cable includes a central conductor. Optical fibers are provided around the central conductor. The optical fibers are disposed within a cladding which surrounds and contacts the central conductor. A jacket surrounds and contacts the cladding. At least one metal tube (including an outer metal tube) surrounds the jacket.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a cross-sectional view of a downhole logging cable in accordance with one embodiment of the present disclosure;

FIG. 2 is a cross-sectional view of a downhole logging cable in accordance with another embodiment of the present disclosure;

FIG. 3 is a cross-sectional view of a downhole logging cable in accordance with another embodiment of the present disclosure; and

FIG. 4 is a cross-sectional view of a downhole logging cable in accordance with another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present disclosure generally provides an improved downhole logging cable. Logging cables in accordance with the present disclosure are advantageously reusable and have relatively small profiles. Additionally, logging cables in accordance with the present disclosure advantageously provide improved strength, temperature resistance, and bending stiffness characteristics while being capable of maintaining electrical and optical pathways to connected logging instruments. In particular, logging cables in accordance with the present disclosure can operate at relatively extreme temperatures, such as at least as low as −5 degrees Celsius and at least as high as 175 degrees Celsius, without damage to components of the cable. In addition, logging cables in accordance with the present disclosure can withstand tensile loads of up to 2000 pounds or more without damage to components of the cable.

Cables in accordance with the present disclosure include a central conductor. Optical fibers are provided around the central conductor. The optical fibers are disposed within a cladding which surrounds and contacts the central conductor. A jacket surrounds and contacts the cladding. At least one metal tube surrounds the jacket. In exemplary embodiments, a maximum outer diameter of an outer metal tube is less than 4.2 millimeters, such as between 4.1 millimeters and approximately 3.9 millimeters, such as approximately 4 millimeters.

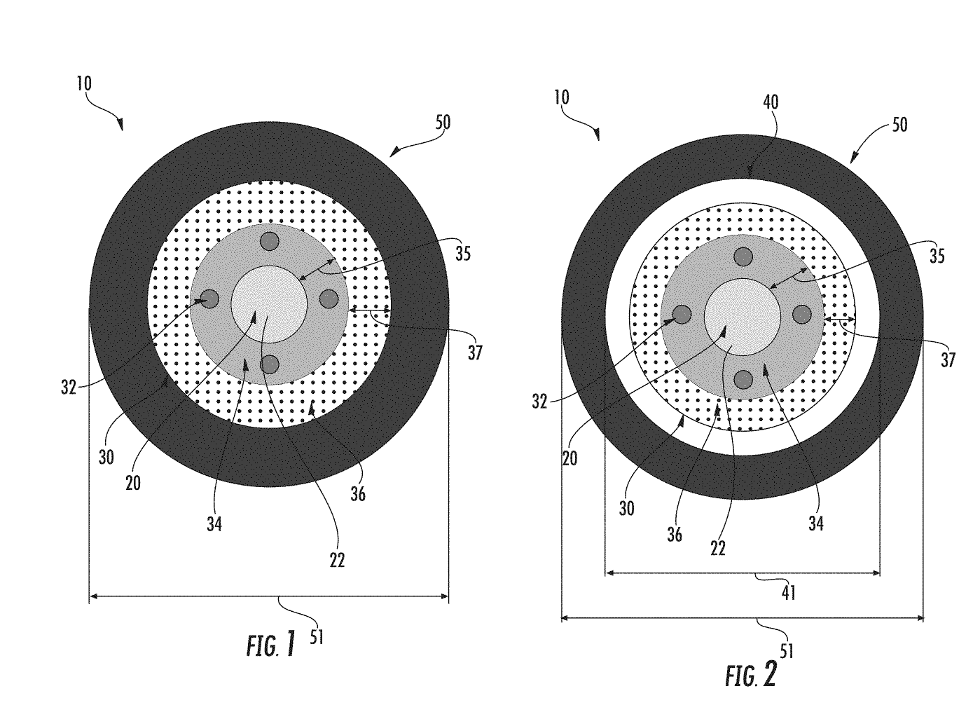

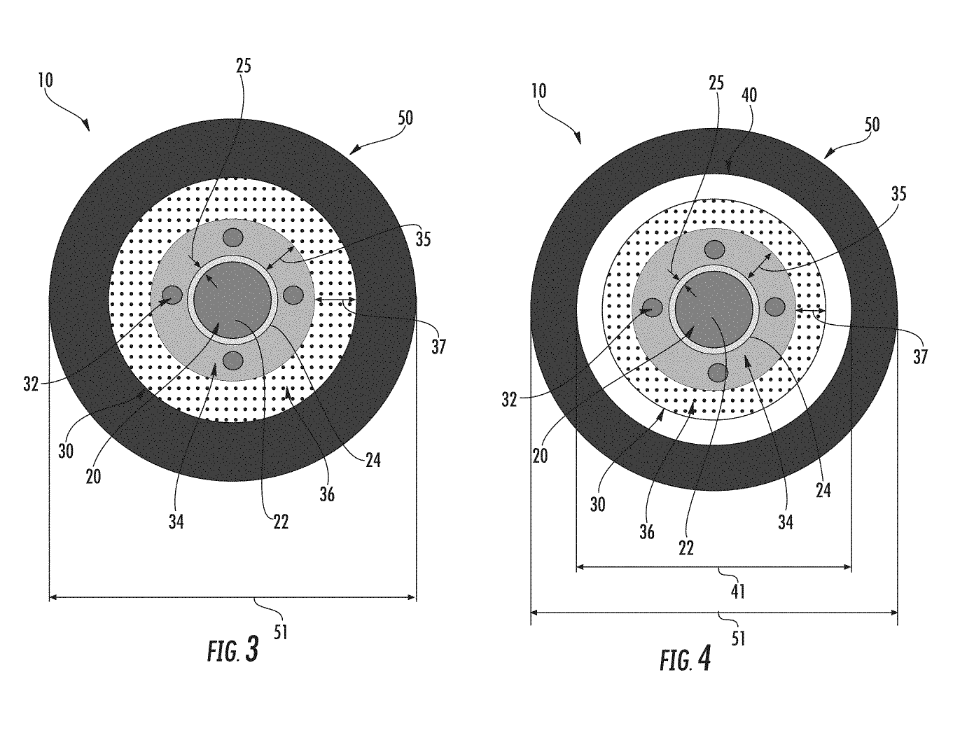

Referring now to FIGS. 1 through 4, a downhole logging cable 10 in accordance with the present disclosure is illustrated. Cable 10 includes a central conductor 20. The conductor 20 may include a conductor wire 22 and an optional coating layer 24 surrounding and in contact with the conductor wire 22. The conductor wire 22 may, in exemplary embodiments, be formed from copper. In some embodiments as illustrated in FIGS. 1 and 2, the conductor 20 may in exemplary embodiments be a bare wire (such as a bare copper wire), thus including only the conductor wire 22 with no coating layer 24. Alternatively, as illustrated in FIGS. 3 and 4, the conductor 20 may additionally include the coating layer 24. In exemplary embodiments, 18 American Wire Gauge (“AWG”) wire may be utilized for the conductor wire 22, although alternatively suitable conductor wires may be in the range from 18 AWG to 28 AWG. The coating layer 24 may, in exemplary embodiments, be or include a fluoropolymer or a thermoplastic polymer such as a polyamide. A thickness 25 of the coating may, for example, be in the range between 0.002 mm to 0.25 mm.

An optical unit 30 may surround the conductor 20. Optical unit 30 may include one or more optical fibers 32. Optical fibers 32 may be single mode or multi-mode optical fibers. In exemplary embodiments as illustrated, four or five optical fibers 32 are provided in the optical unit 30, although alternatively the number of optical fibers 32 may be between one and twelve. The optical fibers 32 may be spaced from the conductor 20 so as to not contact the conductor 20. Further, the optical fibers 32 may be spaced apart from each other in an annular array about the conductor 20, as illustrated.

The optical fibers 32 may in exemplary embodiments be stranded along a length of the cable 10 and about the conductor 20, such as having a lay length of between 90 millimeters and 350 millimeters, such as between 130 millimeters and 250 millimeters, such as between 140 millimeters and 160 millimeters, such as approximately 150 millimeters. Alternatively, the optical fibers 32 may extend generally linearly along the length of the cable 10.

A cladding 34 may surround and encase the optical fibers 32. The cladding in exemplary embodiments may be formed from silicone. The cladding 34 may additionally surround and contact the conductor 20, thus being disposed between the conductor 20 and optical fibers 32.

A jacket 36 may surround and contact the cladding 34. The jacket 36 may be formed from a suitable fluoropolymer, such as a polymethylpentene (i.e. TPX® manufactured by Mitsui Chemicals, Inc.). The jacket 36 may advantageously protect the other components of the optical unit 30 (specifically the optical fibers 32) as well as the conductor 20, allowing these components to withstand extreme temperatures and to maintain desired performance over the course of repeated uses involving repeated installations and withdrawals.

Notably, the cladding 34 and jacket 36 may be free from reinforcing fibers (or any fibers other than optical fibers 22).

The cladding 34 and jacket 36 may have relatively small maximum thicknesses. For example, the cladding 34 may have a maximum thickness 35 of between 0.3 millimeters and 0.5 millimeters, such as between 0.3 millimeters and 0.4 millimeters, such as between 0.32 millimeters and 0.37 millimeters, such as approximately 0.35 millimeters. The thickness of the jacket 36 may be depended upon the number of metal tubes utilized in the cable 10. For example, in some embodiments as illustrated in FIGS. 1 and 3 (i.e. when only a single metal tube is utilized) the jacket 36 may have a maximum thickness 37 of between 0.25 millimeters and 0.42 millimeters, such as between 0.3 millimeters and 0.42 millimeters, such as between 0.38 millimeters and 0.42 millimeters, such as between 0.39 millimeters and 0.41 millimeters, such as approximately 0.4 millimeters. In other embodiments as illustrated in FIGS. 2 and 4 (i.e. when two or more metal tubes are utilized), the jacket 36 may have a maximum thickness 37 of between 0.18 millimeters and 0.22 millimeters, such as between 0.19 millimeters and 0.21 millimeters, such as approximately 0.2 millimeters.

As discussed, one or more metal tubes may surround the optical unit 30. When more than one metal tube is utilized, the tubes may be formed from the same or different materials. For example, in exemplary embodiments, the metal tube(s) may each be formed from a steel, such as a stainless steel. 825, 316 or 625 grade steels are suitable for use as metal tube(s).

In some embodiments as illustrated in FIGS. 2 and 4, an inner metal tube 40 may surround and contact the optical unit 30, such as the jacket 36 thereof. The inner metal tube 40 may have relatively small maximum outer diameter. For example, the maximum outer diameter 41 of the inner metal tube 40 may be between approximately 2.4 millimeters and 2.7 millimeters, such as between 2.5 millimeters and 2.6 millimeters, such as approximately 2.53 millimeters.

Cable 10 may further include an outer metal tube 50. The outer metal tube 50 may surround and contact the optical unit 30, such as the jacket 36 thereof (as illustrated in FIGS. 1 and 3) or the inner metal tube 40 (as illustrated in FIGS. 2 and 4). The outer metal tube 50 protects the various interior components 20, 30, 40, thus acting as a protective layer for the cable 10 generally. The outer metal tube 50 may be the outermost layer defining an exterior surface of the cable 10.

The outer metal tube 50 (and thus the cable 10 generally) may have a relatively small maximum outer diameter 51. For example, the maximum outer diameter 51 may be less than 4.2 millimeters, such as between 4.1 millimeters and approximately 3.9 millimeters, such as approximately 4 millimeters.

As discussed, downhole logging cables 10 in accordance with the present disclosure advantageously provide improved strength, temperature resistance, and bending stiffness characteristics while being capable of maintaining electrical and optical pathways to connected logging instruments. In particular, a cable 10 in accordance with the present disclosure may have a particularly desirable bending stiffness. The bending stiffness of a cable in accordance with the present disclosure may, for example, have a K value of between 1.2 lb/in and 1.3 lb/in, such as approximately 1.228 lb/in. The K value may be calculated by suspending a cable sample and introducing a load perpendicular to the cable in the middle of the cable. The K value is the result of the deflection of the cable divided by the introduced load.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A downhole logging cable, comprising:
a central conductor;
an optical unit surrounding and contacting the conductor, the optical unit comprising at least one optical fiber, a cladding, and a jacket, the cladding surrounding and encasing the at least one optical fiber, the jacket surrounding and encasing the cladding; and
at least one metal tube surrounding the optical unit.

2. The downhole logging cable of claim 1, wherein the central conductor comprises a bare wire in contact with the cladding.

3. The downhole logging cable of claim 1, wherein the central conductor comprises a wire and a coating layer surrounding and in contact with the wire, the coating layer further in contact with the cladding.

4. The downhole logging cable of claim 1, wherein the central conductor comprises a copper wire.

5. The downhole logging cable of claim 1, wherein the at least one optical fiber is spaced from the central conductor.

6. The downhole logging cable of claim 1, wherein the cladding is formed from a silicone and the jacket is formed from a fluoropolymer.

7. The downhole logging cable of claim 1, wherein the at least one metal tube comprises an outer metal tube, the outer metal tube being an outermost layer defining an exterior surface of the cable.

8. The downhole logging cable of claim 7, wherein the outer metal tube contacts the optical unit.

9. The downhole logging cable of claim 7, wherein the at least one metal tube further comprises an inner metal tube, the inner metal tube disposed between and in contact with the optical unit and the outer metal tube.

10. The downhole logging cable of claim 1, wherein the at least one metal tube is formed from a steel.

11. The downhole logging cable of claim 1, wherein a maximum outer diameter of the cable is less than 4.2 millimeters.

12. The downhole logging cable of claim 1, wherein the cable has a K value of between 1.2 lb/in and 1.3 lb/in.

13. A downhole logging cable, comprising:
a central conductor;
an optical unit surrounding and contacting the conductor, the optical unit comprising at least one optical fiber, a cladding, and a jacket, the at least one optical fiber spaced from the central conductor, the cladding surrounding and encasing the at least one optical fiber, the jacket surrounding and encasing the cladding, wherein the cladding is formed from a silicone and the jacket is formed from a fluoropolymer; and
at least one metal tube surrounding the optical unit, wherein the at least one metal tube comprises an outer metal tube, the outer metal tube being an outermost layer defining an exterior surface of the cable.

14. The downhole logging cable of claim 13, wherein the central conductor comprises a bare wire in contact with the cladding.

15. The downhole logging cable of claim 13, wherein the central conductor comprises a wire and a coating layer surrounding and in contact with the wire, the coating layer further in contact with the cladding.

16. The downhole logging cable of claim 13, wherein the central conductor comprises a copper wire.

17. The downhole logging cable of claim 13, wherein the outer metal tube contacts the optical unit.

18. The downhole logging cable of claim 13, wherein the at least one metal tube further comprises an inner metal tube, the inner metal tube disposed between and in contact with the optical unit and the outer metal tube.

19. The downhole logging cable of claim 13, wherein a maximum outer diameter of the cable is less than 4.2 millimeters.

20. The downhole logging cable of claim 13, wherein the cable has a K value of between 1.2 lb/in and 1.3 lb/in.
